(19) United States
(12) Patent Application Publication
(10) Pub. No.: US 2026/0251813 A1
(43) Pub. Date: Aug. 27, 2026

(54) NUCLEAR MAGNETIC RESONANCE (NMR) MOTION CORRECTION USING MODE DECOMPOSITION IN WELL SYSTEMS

(71) Applicant: Halliburton Energy Services, Inc., Houston, TX (US)

(72) Inventors: Yunke Liu, Houston, TX (US); Boguslaw Wiecek, Houston, TX (US); Rebecca Jachmann, Houston, TX (US); Jie Yang, Houston, TX (US)

(21) Appl. No.: 19/065,853

(22) Filed: Feb. 27, 2025

(51) Int. Cl. G01V 3/32; E21B 49/00; G01V 3/38

(52) U.S. Cl. CPC G01V 3/32; E21B 49/00; G01V 3/38

(57) ABSTRACT

Systems, methods, and apparatus, including computer programs encoded on computer-readable media, for obtaining nuclear magnetic resonance (NMR) measurements of a subsurface formation in a well system. NMR echo data having motion artifacts may be determined in response to performing downhole NMR measurements using an NMR tool of the well system. Mode decomposition may be performed on the NMR echo data to decompose the NMR echo data having the motion artifacts into a plurality of sub-signals associated with a corresponding plurality of modes. Corrected NMR echo data having reduced motion artifacts may be determined based on one or more of the plurality of sub-signals associated with the decomposed NMR echo data. Properties of the subsurface formation may be determined from the NMR echo data having the reduced motion artifacts.

### TECHNICAL FIELD

The present invention relates generally to oil and gas systems and services, and more specifically to nuclear magnetic resonance (NMR) motion correction using mode decomposition in well systems.

### BACKGROUND

The oil and gas services industry uses various types of well equipment and tools in well systems at well sites. Well systems may use nuclear magnetic resonance (NMR) tools for NMR logging of the subsurface formation of a well for hydrocarbon reservoir evaluation. For example, the NMR logging may indicate various properties of the subsurface formation, such as the volume (e.g., porosity) and distribution (e.g., permeability) of the rock pore space, the rock composition, the type and quality of the fluids (e.g., water and hydrocarbons), and hydrocarbon producibility. NMR measurement data, such as NMR echo data, obtained from the NMR tool during NMR logging is sensitive to the motion of the NMR tool. For example, when the NMR tool is used in a logging while drilling (LWD) or a measurement while drilling (MWD) context, the longitudinal and lateral displacement due to the motion of the NMR tool can distort or introduce motion artifacts or noise into the NMR echo data. Since the motion of the NMR tool can distort or corrupt the NMR echo data, the analysis of the corrupted NMR echo data can result in the determination of inaccurate properties of the subsurface formation unless the corrupted NMR echo data is processed to reduce the motion artifacts.

### BRIEF DESCRIPTION OF THE DRAWINGS

FIG. 1 depicts a schematic diagram of an example well system including a nuclear magnetic resonance (NMR) tool, according to some implementations.

FIG. 2 depicts a workflow of example operations for reducing motion artifacts from NMR echo data using mode decomposition when total porosity is known, according to some implementations.

FIG. 3 depicts an example signal diagram of NMR echo data with motion artifacts and ground truth, according to some implementations.

FIG. 4 depicts a workflow of example operations for reducing motion artifacts from NMR echo data using mode decomposition when motion data is known, according to some implementations.

FIG. 5 depicts a workflow of example operations for reducing motion artifacts from NMR echo data using mode decomposition when total porosity and motion are not known, according to some implementations.

FIG. 6A depicts an example plot of NMR echo train having motion artifacts, ground truth, and the first sub-signals after decomposing NMR echo data with motion artifacts in the time domain, according to some implementations.

FIG. 6B depicts an example plot of the remaining K sub-signals after decomposing NMR echo data with motion artifacts in the time domain, according to some implementations.

FIG. 6C depicts an example plot of NMR echo train having motion artifacts, ground truth, and the first sub-signals after decomposing NMR echo data with motion artifacts in the frequence domain, according to some implementations.

FIG. 6D depicts an example plot of the remaining K sub-signals after decomposing NMR echo data with motion artifacts in the frequency domain, according to some implementations.

FIG. 6E depicts an example plot of NMR echo train having motion artifacts, ground truth, and the corrected NMR echo train with reduced motion artifacts, according to some implementations.

FIG. 6F depicts an example plot of spectrum data after inversion, according to some implementations.

FIG. 7 is a flowchart of example operations for obtaining NMR measurements of a subsurface formation in a well system, according to some implementations.

FIG. 8 depicts an example computer system of a well system for performing NMR measurements of a subsurface formation, according to some implementations.

FIG. 9 shows an example well system that includes an NMR tool in a wireline logging environment, according to some implementations.

FIG. 10 shows an example well system that includes an NMR tool in a drilling environment, according to some implementations.

FIG. 11 is a diagram of an example NMR magnet and antenna(s) configuration, according to some implementations.

### DESCRIPTION

The description that follows includes example systems, methods, techniques, and program flows that describe aspects of the disclosure. However, it is understood that this disclosure may be practiced without these specific details. For instance, this disclosure refers to certain well systems, devices, or tools in illustrative examples. Aspects of this disclosure can be instead applied to other types of well systems, devices, and tools. In other instances, well-known instruction instances, protocols, structures, and techniques have not been shown in detail to avoid confusion.

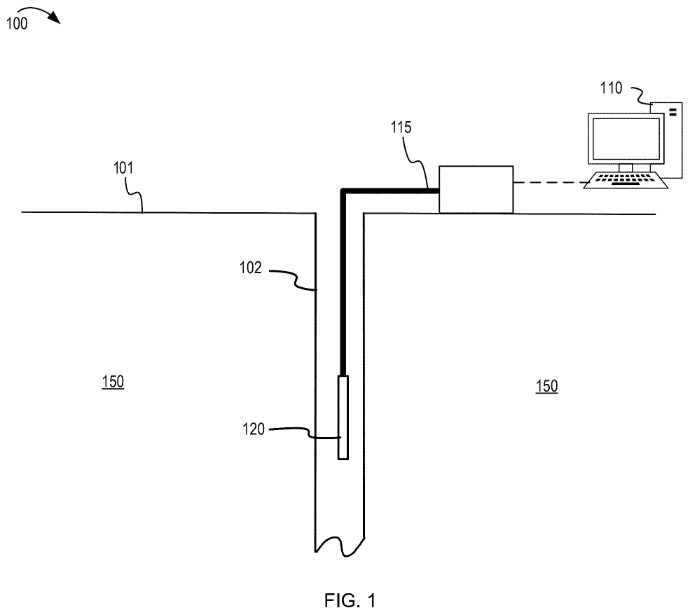

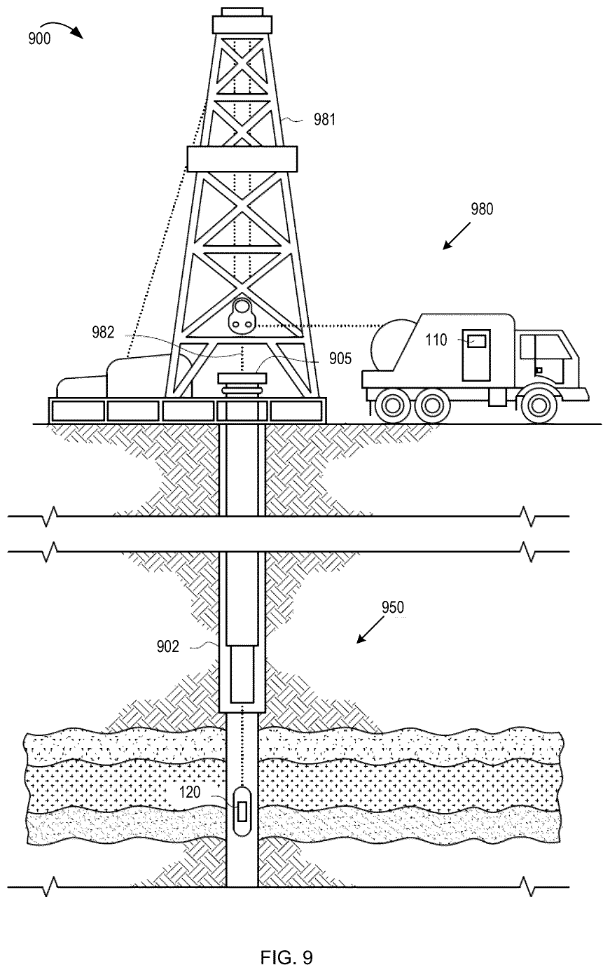

FIG. 1 depicts a schematic diagram of an example well system 100 including a nuclear magnetic resonance (NMR) tool, according to some implementations. In some implementations, the well system 100 may include a wellbore 102, surface equipment and tools, such as the computer system 110, and downhole equipment and tools, such as the NMR tool 120. The well system 100 may also include a cable 115 (e.g., a wireline) or other mechanism (such as a work string or drill string) that can lower the NMR tool 120 downhole into the wellbore 102 (or borehole). FIG. 1 shows a portion of the wellbore 102 and well system 100 for simplicity. It is noted that the well system 100 may include additional equipment, devices, tools and other components at the surface 101 or downhole that are not shown for simplicity. The well system 100 may use the NMR tool 120 for NMR logging of the subsurface formation 150 of the wellbore 102 for hydrocarbon reservoir evaluation. For example, the NMR logging may indicate various properties of the subsurface formation 150, such as the volume (e.g., porosity) and distribution (e.g., permeability) of the rock pore space, the rock composition, the type and quality of the fluids (e.g., water and hydrocarbons), and hydrocarbon producibility, among others. Therefore, the NMR measurements and other NMR data obtained from the NMR logging can be used for well site planning, well drilling, hydrocarbon recovery operations, and other well operations. Non-limiting examples of the well system 100 and the NMR tool 120 are further described in FIGS. 9-11.

In some implementations, the well system 100 may obtain NMR echo data from the NMR tool 120. The NMR echo data may be sensitive to the motion of the NMR tool 120 and thus the NMR echo data may include motion artifacts from the downhole motion of the NMR tool 120. For example, when the NMR tool 120 is used in a logging while drilling (LWD) or a measurement while drilling (MWD) context, the longitudinal and lateral displacement due to the motion of the NMR tool 120 can distort, corrupt, or introduce motion artifacts into the NMR echo data. The motion artifacts may also be referred to as motion-based noise or motion noise. Since the motion of the NMR tool 120 can distort or corrupt the NMR echo data, the corrupted NMR echo data may lead to inaccurate results, such as the determination of inaccurate properties of the subsurface formation. For at least these reasons, the well system 100 may reduce the motion artifacts of the NMR echo data using mode decomposition operations before further processing the NMR echo data to determine the subsurface formation properties.

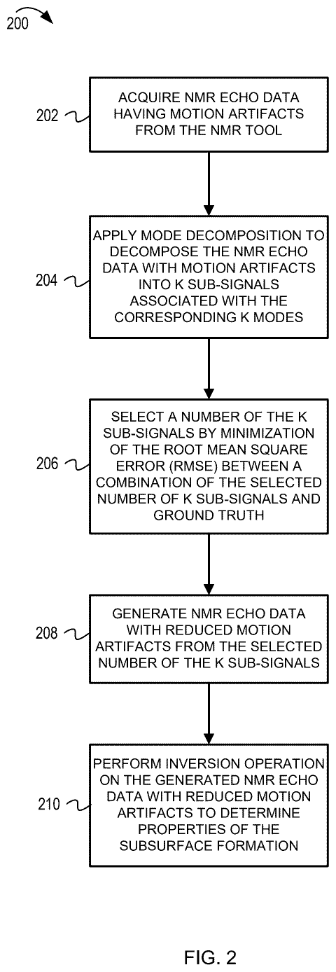

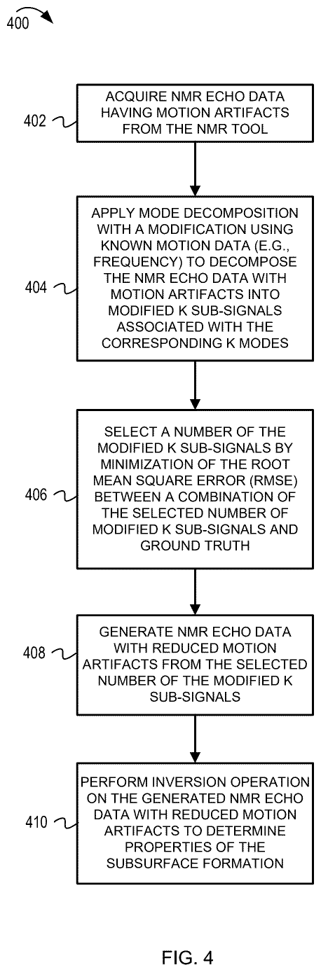

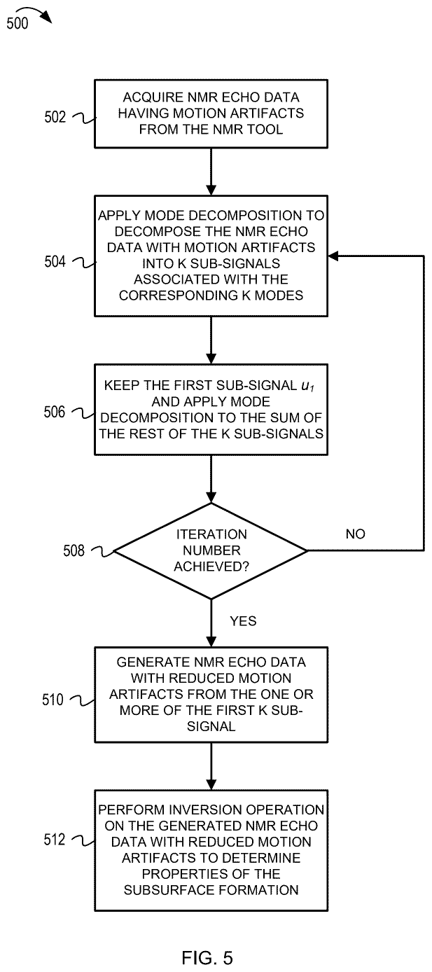

In some implementations, the well system 100 may reduce the motion artifacts using any one of at least three motion correcting techniques. If total porosity associated with the subsurface formation is known or can be determined, the motion artifacts of the NMR echo data can be reduced using the first technique shown in FIG. 2. If a frequency or other motion data is known or can be determined, the motion artifacts of the NMR echo data can be reduced using the second technique shown in FIG. 4. If neither total porosity or motion data (e.g., frequency) is known or cannot be determined, the motion artifacts of the NMR echo data can be reduced using the third technique shown in FIG. 5.

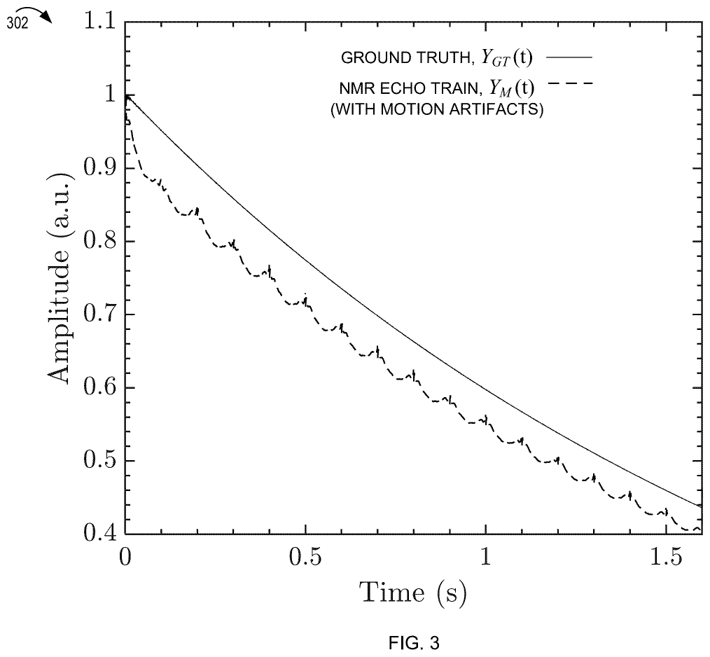

FIG. 2 depicts a workflow of example operations for reducing motion artifacts from NMR echo data using mode decomposition when total porosity is known, according to some implementations. In some implementations, the well system 100 may acquire NMR echo data having motion artifacts from the NMR tool 120, as shown in block 202 of FIG. 2. For example, the computer system 110 (or other type of surface equipment or computing device) of the well system 100 may obtain the NMR echo data with motion artifacts from the NMR tool 120. In some implementations, the NMR echo data with motion artifacts are NMR echo waveforms with motion artifacts, which may also be referred to as NMR echo waveform data with motion artifacts. In some implementations, the NMR echo waveforms obtained from the NMR tool 120 can be processed to generate or obtain NMR echo trains, which also may be referred to as NMR echo train data. The NMR echo data having motion artifacts, such as the NMR echo waveforms or the NMR echo trains, may then be processed using mode decomposition to reduce the motion artifacts, as further described below. FIG. 3 depicts an example signal diagram 302 of NMR echo data with motion artifacts and ground truth, according to some implementations. As shown in FIG. 3, one example of the NMR echo data with motion artifacts may be an NMR echo train with motion artifacts, and the ground truth may be an NMR echo train with no motion artifacts.

In some implementations, the well system 100 may apply mode decomposition to the NMR echo data having motion artifacts to decompose the NMR echo data having motion artifacts into K sub-signals associated with the corresponding K modes, as shown in block 204 of FIG. 2. For example, the NMR echo data having motion artifacts may be decomposed into K=5 sub-signals associated with K=5 modes, e.g., mode 0, mode 1, mode 2, mode 3 and mode 4. In some examples, the sub-signals associated with the different modes may also be referred to as intrinsic mode functions (IMFs). In some implementations, the mode decomposition that is applied to the NMR echo data having motion artifacts may be Variational Mode Decomposition (VMD) or Supervised VMD (SVMD), as further described below. It is noted, however, that other types of mode decomposition or supervised mode decomposition may be implemented by the well system 100, such as Empirical Mode Decomposition (EMD) or Principal Component Analysis (PCA), among others.

In some implementations, the well system 100 may select a number of the K sub-signals by minimization of the root mean square error (RMSE) between a combination of the selected number of K sub-signals and the ground truth, as shown in block 206 of FIG. 2. The selected number of the K sub-signals may be associated with a corresponding number of the K modes. In some implementations, when the total porosity of the subsurface formation (or a section or portion of the subsurface formation) is known or can be determined, the ground truth can be determined or derived based on the total porosity. In some implementations, the ground truth may be a ground truth total signal intensity. In some implementations, the total porosity can be derived or determined by an additional downhole tool, such as a neutron tool, and/or by a plurality of T2 echos, and/or by T1 build up with known T1/T2 ratio, among others. In some implementations, the well system 100 may select a number of the K sub-signals and hyperparameters that minimize the RMSE between the combination of the selected number of K sub-signals and the ground truth. In some implementations, the well system 100 may select a first sub-signal (e.g., mode 0) and the maximum amplitude of one or more additional sub-signals and determine whether the RMSE between the combination of the selected sub-signals and the ground truth (e.g., ground truth total signal intensity) has been minimized or is close to zero. For example, when K=2, the first sub-signal (e.g., mode 0) and a second sub-signal (e.g., mode 1) can be selected, and it can be determined whether the RMSE between the combination of the selected two sub-signals and the ground truth has been minimized or is close to zero. The next K then be evaluated. For example, when K=3, the first sub-signal (e.g., mode 0), a second sub-signal (e.g., mode 1), and a third sub-signal (e.g., mode 2) can be selected, and it can be determined whether the RMSE between the combination of the selected three sub-signals and the ground truth has been minimized or is close to zero. The evaluation process can continue with one or more additional K's. Then, the K is selected that minimizes the RMSE between the selected sub-signals and the ground truth. When the RMSE is minimized, this means the combination of the selected sub-signals is very similar to the ground truth and thus the motion artifacts have been minimized or reduced from the original signal. A non-limiting example algorithm for implementing mode decomposition (e.g., SVMD) is shown below.

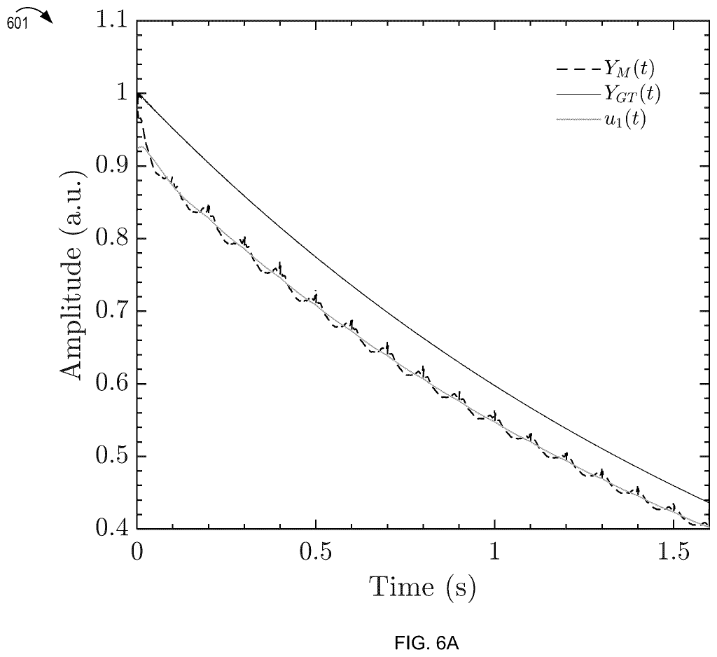

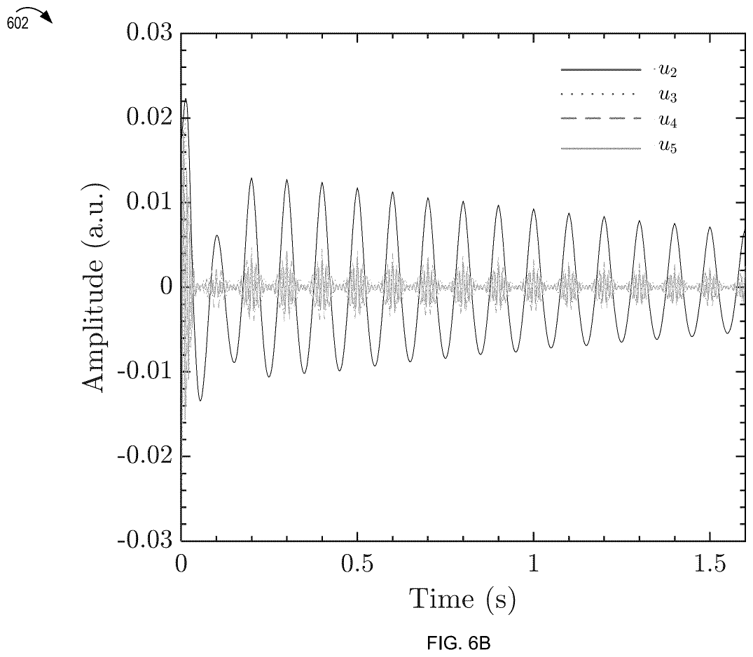

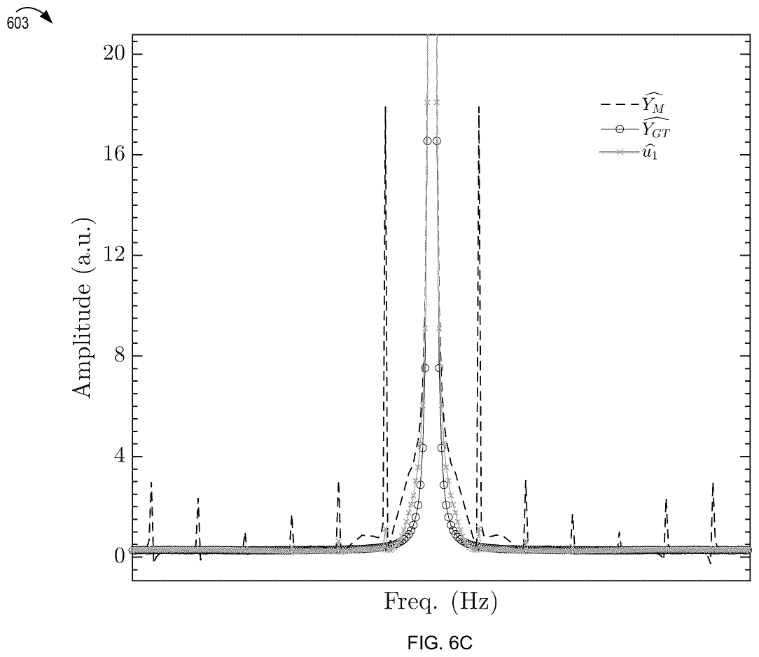

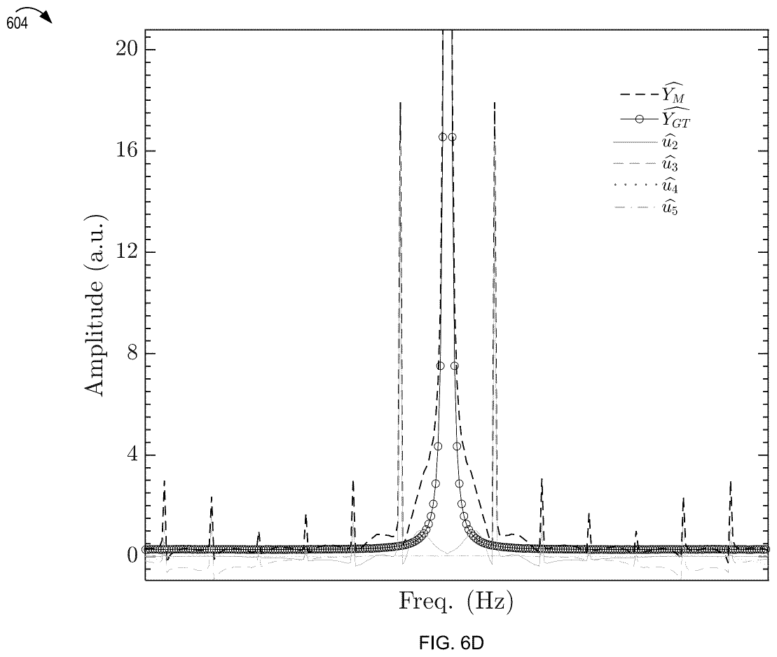

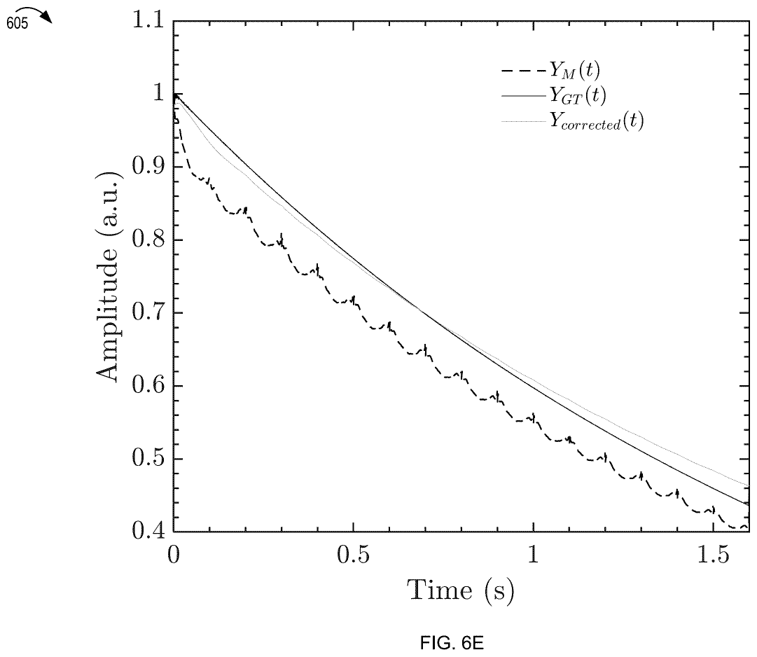

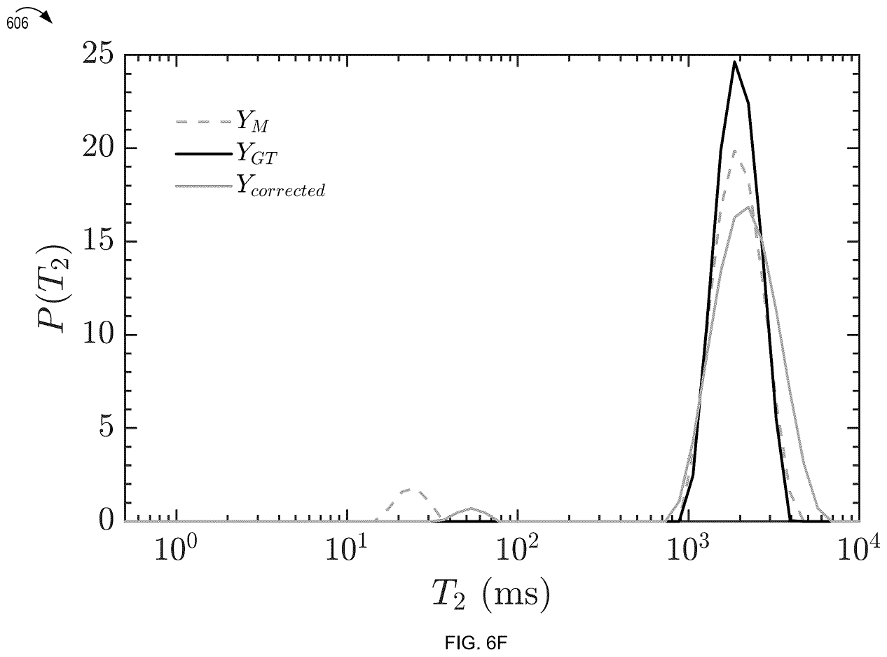

In some implementations, the well system 100 may generate the NMR echo data with reduced motion artifacts from the selected number of K sub-signals, as shown in block 208 of FIG. 2. For example, the NMR echo data (e.g., NMR echo train) with reduced motion artifacts can be generated from the selected number of K sub-signals associated with the corresponding number of modes. FIGS. 6A and 6B depict a non-liming example of NMR echo data (e.g., NMR echo train) having motion artifacts, the decomposed K sub-signals that are analyzed for the minimization of the RMSE, and a ground truth. In the plot 601 of FIG. 6A, the NMR echo train having motion artifacts (Y_{M}(t)) is shown by black dash curve, the ground truth (Y_{GT}(t)) is shown by black solid curve and the first mode after decomposition, which may be referred to u₁ and correspond to mode 0, is shown by the grey solid curve. In the plot 602 of FIG. 6B, the rest of K=5 sub-signals, which may be referred to u₂-u₅ and correspond to modes 1-4 are shown by black solid, grey dot, grey dash and grey solid curve. In one non-limiting example, when K=2, the u₁ or mode 0 sub-signal and the u₂ or mode 1 sub-signal may minimize the RMSE between the combination of these sub-signals and the ground truth. Therefore, in this example, the u₁ or mode 0 sub-signal and the u₂ or mode 1 sub-signal may be selected and used to generate the NMR echo train having reduced motion artifacts (as shown by the grey solid curve in FIG. 6E). FIGS. 6C and 6D depict a non-liming example of NMR echo data (e.g., NMR echo train) having motion artifacts, the decomposed K sub-signals that are analyzed for the minimization of the RMSE and a ground truth, in the frequency domain. In the plot 603 of FIG. 6C, the NMR echo train having motion artifacts is shown by black dash curve, the ground truth is shown by black solid curve with open circle marker and the first mode after decomposition, which may be referred to as [symbol] and correspond to mode 0, is shown by the grey solid curve with star marker. In the plot 604 of FIG. 6D, the rest of K=5 sub-signals, which may be referred to as [symbol] - [symbol] are shown by grey solid, grey dash, grey dot, and grey dash dot curve, respectively. FIGS. 6E and 6F depict a non-liming example of NMR echo data (e.g., NMR echo train) having motion artifacts, a ground truth, and corrected NMR echo data (e.g., corrected NMR echo train) with reduced motion artifacts. As shown in the plot 605 of FIG. 6E, one example of the NMR echo data with reduced motion artifacts may be an NMR echo train with reduced motion artifacts. Compared to the NMR echo train shown in FIG. 3 that has significant motion artifacts or noise, the corrected NMR echo train shown in FIG. 6E is a much cleaner echo train with reduced motion artifacts or noise. The plot 606 of FIG. 6F shows one example of the NMR echo train with motion artifacts, a ground truth and corrected NMR echo train after inversion. Compared to the NMR echo train that has significant motion artifacts or noise, the plot 606 shows a shorter relaxation peak and lower porosity. The shorter relaxation peak of the corrected NMR echo train with reduced motion artifacts is much smaller than the original NMR echo train and can be used to recover the total porosity associated with the subsurface formation. It is noted that although some implementations described herein disclose examples of mode decomposition in the frequency domain to reduce motion artifacts, in other implementations mode decomposition or similar techniques to reduce motion artifacts can be applied in other domains. For example, principal component analysis can also be used to reduce motion artifacts in the spatial domain as long as a transfer function/filter can be found, which can also be treated as mode decomposition, or in the spectra domain if the inversion algorithm itself is treated as a filter.

In some implementations, the well system 100 may utilize the NMR echo data (e.g., the NMR echo train) with reduced motion artifacts for determining properties of the subsurface formation and performing well operations based on the properties. In some implementations, the well system 100 may perform an inversion operation on the NMR echo data (e.g., the NMR echo train data) with reduced motion artifacts to determine the properties of the subsurface formation, as shown in block 210 of FIG. 2. For example, a non-negative least square inversion algorithm Y=AX can be performed on the NMR echo data with reduced motion artifacts, or a multi-dimensional inversion operation (or other types of inversion operations) can be performed on the NMR echo data with reduced motion artifacts, as shown in FIG. 6F. After reducing the motion artifacts, the NMR echo data be used by various tools and products and services for NMR logging and well-related tasks. The well system 100 may use the NMR echo data with reduced motion artifacts and other NMR measurements for NMR logging of the subsurface formation of the wellbore for hydrocarbon reservoir evaluation. For example, the NMR logging may indicate various properties of the subsurface formation, such as the volume (e.g., porosity) and distribution (e.g., permeability) of the rock pore space, the rock composition, the type and quality of the fluids (e.g., water and hydrocarbons), and hydrocarbon producibility, among others. Therefore, the NMR measurements and other data obtained from the NMR logging can be used for well site planning, hydrocarbon recovery operations, and other well operations. In some implementations, well operations associated with the subsurface formation (e.g., such as drilling the well or hydrocarbon recovery) can be determined or modified based on the properties of the subsurface formation derived from the NMR measurements, such as the NMR echo data with reduced motion artifacts.

As described above, in some implementations, VMD or SVMD can be implemented to perform the operations described in blocks 204 and 206 of FIG. 2. A non-limiting example of an VMD algorithm for performing the operations of FIG. 2 is described below. In some implementations, the objective function of VMD is a constraint convex function by limiting the bandwidth of each K sub-signals uₖ(t), as shown below in Equations 1.1 and 1.2:

$${min}_{{u}_{k} , {ω}_{k}} {\sum }_{k = 1}^{K} {‖ [ {\partial }_{t} ( {δ}_{t} + \frac{j}{π t} ) * {u}_{k} ( t ) ] {e}^{- j {ω}_{k} t} ‖}_{2}^{2} , \qquad ( Equation 1.1 )$$

$$s . t . {\sum }_{k = 1}^{K} {u}_{k} ( t ) = {Y}_{M} ( t ) . \qquad ( Equation 1.2 )$$

In Equation 1.1,

$$( {δ}_{t} + \frac{j}{π t} )$$

refers to the Hilbert transform and “*” means convolution of each sub-signal. Then, mixing frequency e^{-jω}^{ₖ}^{t} to each sub-signal and Gaussian smooth with L2 norm are applied to express the bandwidth of each sub-signal in the frequency domain. All sub-signals after the decomposition are made up to the input magnetic resonance imaging logging (MRIL) motion data Y_{M}(t).

This objective function can be solved using augmented Lagrangian function with the Alternating Direction Multiplier Method (ADMM) as shown in Equation 1.3:

$$ℒ = α {\sum }_{k = 1}^{K} {‖ [ {\partial }_{t} ( {δ}_{t} + \frac{j}{n t} ) * {u}_{k} ( t ) ] {e}^{- j {ω}_{k} t} ‖}_{2}^{2} + 〈 λ ( t ) , {Y}_{M} ( t ) - {\sum }_{k = 1}^{K} {u}_{k} ( t ) 〉 + {‖ {Y}_{M} ( t ) - {\sum }_{k = 1}^{K} {u}_{k} ( t ) ‖}_{2}^{2} . \qquad ( Equation 1.3 )$$

In Equation 1.3, α is the regularization term for limiting the bandwidth, and λ(t) is the ADMM multiplier. The sub-signal for each iteration can be expressed as shown below in Equation 1.4:

$${u}_{k}^{\{ n + 1 \}} ( t ) = {arg min}_{{u}_{k}} \{ α {\sum }_{k = 1}^{K} {‖ [ {\partial }_{t} ( {δ}_{c} + \frac{j}{π t} ) * {u}_{k} ( t ) ] {e}^{- j {ω}_{k} t} ‖}_{2}^{2} + {‖ {Y}_{M} ( t ) - {\sum }_{k = 1}^{K} {u}_{k} ( t ) + \frac{λ ( t )}{2} ‖}_{2}^{2} \} , \qquad ( Equation 1.4 )$$

$${Y}_{c orrected} = {u}_{k}^{1} + {\sum }_{k = 2}^{{K}_{opt}} max ( {u}_{k}^{{K}_{opt}} ) , \qquad ( Equation 1.5 )$$

$$RMSE = mean ( \sum {( {Y}_{c orrected} ( t ) - {Y}_{G T} ( t ) )}^{2} ) . \qquad ( Equation 1.6 )$$

In Equation 1.5 and 1.6, Y_{corrected}(t) is the corrected NMR echo train with reduced motion artifact by the combination of the selected sub-signals, and Y_{GT} (t) is the ground truth.

FIG. 4 depicts a workflow of example operations for reducing motion artifacts from NMR echo data using mode decomposition when motion data is known, according to some implementations. For example, the motion data may be a frequency obtained from an accelerometer, or other type of motion data obtained from one or more downhole well tools or devices. In some implementations, the well system 100 may acquire NMR echo data having motion artifacts from the NMR tool 120, as shown in block 402 of FIG. 4. For example, the computer system 110 (or other type of surface equipment or computing device) of the well system 100 may obtain the NMR echo data with motion artifacts from the NMR tool 120. In some implementations, the NMR echo data with motion artifacts is NMR echo waveforms with motion artifacts, which may also be referred to as NMR echo waveform data with motion artifacts. In some implementations, the NMR echo waveforms obtained from the NMR tool 120 can be processed to generate or obtain NMR echo trains, which also may be referred to as NMR echo train data. An example of NMR echo data with motion artifacts is shown in FIG. 3.

In some implementations, the well system 100 may apply mode decomposition with a modification using known motion data (e.g., frequency) to decompose the NMR echo data having motion artifacts into modified K sub-signals associated with the corresponding K modes, as shown in block 404 of FIG. 4. In some implementations, a mode decomposition with a modification using a known frequency can be applied to the NMR echo data having motion artifacts to decompose the NMR echo data having motion artifacts into modified K sub-signals associated with the corresponding K modes. The mode decomposition that is modified by a known motion data (e.g., known frequency) may be referred to as a modified mode decomposition or a motion-modified mode decomposition. A non-limiting example algorithm of the modified mode decomposition (e.g., modified SVMD) is shown below. The known motion data or known frequency may be known or can be determined from one or more downhole well tools or devices, such as an accelerometer. In one example, the NMR echo data having motion artifacts may be decomposed into modified K=5 sub-signals associated with K=5 modes, e.g., mode 0, mode 1, mode 2, mode 3 and mode 4. In some examples, the sub-signals associated with the different modes may also be referred to as intrinsic mode functions (IMFs). In some implementations, the modified mode decomposition that is applied to the NMR echo data having motion artifacts may be a modification of Variational Mode Decomposition (VMD) or Supervised VMD (SVMD), as further described below. It is noted, however, that other types of mode decomposition or supervised mode decomposition or other types of modifications may be implemented by the well system 100.

In some implementations, the well system 100 may select a number of the modified K sub-signals by minimization of the root mean square error (RMSE) between a combination of the selected number of the modified K sub-signals and the ground truth, as shown in block 406 of FIG. 4. The selected number of the modified K sub-signals may be associated with a corresponding number of the K modes. In some implementations, the ground truth and the echo data with motion may be generated by a spin dynamics simulator so the hyperparameter K and other parameters can be preconfigured or predetermined. In some implementations, these hyperparameters can be used when we only have the echo train with motion and no ground truth as a reference. In some implementations, the well system 100 may select the number of the modified K sub-signals and the hyperparameters that minimize the RMSE between the combination of the selected number of the modified K sub-signals and the ground truth. In some implementations, the well system 100 may select a first modified sub-signal (e.g., mode 0) and the maximum amplitude of one or more additional modified sub-signals and determine whether the RMSE between the combination of the selected modified sub-signals and the ground truth has been minimized or is close to zero. For example, when K=2, the first modified sub-signal (e.g., mode 0) and a second modified sub-signal (e.g., mode 1) can be selected, and it can be determined whether the RMSE between the combination of the selected two modified sub-signals and the ground truth has been minimized or is close to zero. The next K then be evaluated. For example, when K=3, the first modified sub-signal (e.g., mode 0), a second modified sub-signal (e.g., mode 1), and a third modified sub-signal (e.g., mode 2) can be selected, and it can be determined whether the RMSE between the combination of the selected three modified sub-signals and the ground truth has been minimized or is close to zero. The evaluation process can continue with one or more additional K's. Then, the K is selected that minimizes the RMSE between the selected modified sub-signals and the ground truth. When the RMSE is minimized, this means the combination of the selected modified sub-signals is very similar to the ground truth and thus the motion artifacts have been minimized or reduced from the original signal.

In some implementations, the well system 100 may generate the NMR echo data with reduced motion artifacts from the selected number of modified K sub-signals, as shown in block 408 of FIG. 4. For example, the NMR echo data (e.g., NMR echo train) with reduced motion artifacts can be generated from the selected number of modified K sub-signals associated with the corresponding number of modes. An example of NMR echo data having reduced motion artifacts is shown in FIG. 6E.

In some implementations, the well system 100 may utilize the NMR echo data (e.g., the NMR echo train) with reduced motion artifacts for determining properties of the subsurface formation and performing well operations based on the properties. In some implementations, the well system 100 may perform an inversion operation on the NMR echo data (e.g., the NMR echo train data) with reduced motion artifacts to determine the properties of the subsurface formation, as shown in block 410 of FIG. 4. For example, a non-negative least square inversion algorithm Y=AX can be performed on the NMR echo data with reduced motion artifacts, or a multi-dimensional inversion operation (or other types of inversion operations) can be performed on the NMR echo data with reduced motion artifacts. After reducing the motion artifacts, the NMR echo data be used by various tools and products and services for NMR logging and well-related tasks. The well system 100 may use the NMR echo data with reduced motion artifacts and other NMR measurements for NMR logging of the subsurface formation of the wellbore for hydrocarbon reservoir evaluation. For example, the NMR logging may indicate various properties of the subsurface formation, such as the volume (e.g., porosity) and distribution (e.g., permeability) of the rock pore space, the rock composition, the type and quality of the fluids (e.g., water and hydrocarbons), and hydrocarbon producibility, among others. Therefore, the NMR measurements and other data obtained from the NMR logging can be used for well site planning, hydrocarbon recovery operations, and other well operations. In some implementations, well operations associated with the subsurface formation (e.g., such as drilling the well or hydrocarbon recovery) can be determined or modified based on the properties of the subsurface formation derived from the NMR measurements, such as the NMR echo data with reduced motion artifacts.

As described above, in some implementations, VMD or SVMD can be implemented to perform the operations described in blocks 404 and 406 of FIG. 4. A non-limiting example of an VMD algorithm for performing the operations of FIG. 4 is described below. In some implementations, the objective function of VMD is a constraint convex function with a new constraint ω₂=ωᵢₙₚᵤₜ as a prior knowledge of the input motion frequency from the accelerometer, or acoustic tool, among others. Using the same Equations 1.1 and 1.2 described above, and the new constraint ω₂=ωᵢₙₚᵤₜ, the augmented Lagrangian function of the objective function with the ADMM can be described as shown below in Equation 2.1:

$$ℒ = {ℒ}_{1} + {ℒ}_{2} = α {\sum }_{k = 1}^{K} {‖ [ {\partial }_{t} ( {δ}_{t} + \frac{j}{π t} ) * {u}_{k} ( t ) ] {e}^{- j {ω}_{k} t} ‖}_{2}^{2} + 〈 λ ( t ) , {Y}_{M} ( t ) - {\sum }_{k = 1}^{K} {u}_{k} ( t ) 〉 + {‖ {Y}_{M} ( t ) - {\sum }_{k = 1}^{K} {u}_{k} ( t ) ‖}_{2}^{2} + β ‖ {ω}_{2} - {ω}_{input} ‖ . \qquad ( Equation 2.1 )$$

In Equation 2.1, a is the regularization term for limiting the bandwidth, λ(t) is the ADMM multiplier, and

$${ℒ}_{2} = β {‖ {ω}_{2} - {ω}_{input} ‖}_{2}^{2}$$

describes the minimization of the input motion frequency and one center frequency from the input motion data. The Gaussian smooth with L2 norm is applied with the regularization term β to avoid an overfitting problem.

FIG. 5 depicts a workflow of example operations for reducing motion artifacts from NMR echo data using mode decomposition when total porosity and motion are not known, according to some implementations. In some implementations, the well system 100 may acquire NMR echo data having motion artifacts from the NMR tool 120, as shown in block 502 of FIG. 5. For example, the computer system 110 (or other type of surface equipment or computing device) of the well system 100 may obtain the NMR echo data with motion artifacts from the NMR tool 120. In some implementations, the NMR echo data with motion artifacts is NMR echo waveforms with motion artifacts, which may also be referred to as NMR echo waveform data with motion artifacts. In some implementations, the NMR echo waveforms obtained from the NMR tool 120 can be processed to generate or obtain NMR echo trains, which also may be referred to as NMR echo train data. An example of NMR echo data with motion artifacts is shown in FIG. 3.

In some implementations, the well system 100 may apply mode decomposition to the NMR echo data having motion artifacts to decompose the NMR echo data having motion artifacts into K sub-signals associated with the corresponding K modes, as shown in block 504 of FIG. 5. For example, the NMR echo data having motion artifacts may be decomposed into K=5 sub-signals associated with K=5 modes, e.g., mode 0, mode 1, mode 2, mode 3 and mode 4. In some examples, the sub-signals associated with the different modes may also be referred to as intrinsic mode functions (IMFs). In some implementations, the mode decomposition that is applied to the NMR echo data having motion artifacts may be Variational Mode Decomposition (VMD) or Supervised VMD (SVMD). It is noted, however, that other types of mode decomposition or supervised mode decomposition may be implemented by the well system 100.

In some implementations, the first sub-signal u₁, which may correspond to the mode 0, may be kept and mode decomposition may be applied to the sum of the rest of the K sub-signals

$${\sum }_{k = 2}^{K} {u}_{k} ,$$

as shown in block 506 of FIG. 5. It is determined whether the iteration number for the mode decomposition has been achieved, as shown in block 508 of FIG. 5. One or more mode decompositions may be performed until the iteration number is achieved. The iteration number can be preconfigured or predetermined or a default iteration number can be used. For example, if the iteration number is 1, it is determined that the iteration number has been achieved and the process continues. If the iteration number is 2, the process loops back and a second mode decomposition is performed to

$${\sum }_{k = 2}^{K} {u}_{k} ,$$

which results in a new u₁′ and the rest of the corresponding K sub-signals

$${\sum }_{k = 2}^{K} {u}_{k}^{′} .$$

If the iteration number is 3, the process loops back and a third mode decomposition is performed to

$${\sum }_{k = 2}^{K} {u}_{k}^{′} ,$$

which results in a new

$${u}_{1}^{″}$$

and the rest of the corresponding K sub-signals

$${\sum }_{k = 2}^{K} {u}_{k}^{″} .$$

The iteration number can be a number greater than 3 and similar calculations are performed.

In some implementations, the well system 100 may generate the NMR echo data with reduced motion artifacts from the one or more of the first K sub-signals, as shown in block 510 of FIG. 5. For example, after the iteration number is achieved, the NMR echo data with reduced motion artifacts may be generated from the sum of the one or more of the first K sub-signals. In one example, when the iteration number is 1, the NMR echo data (e.g., NMR echo train) with reduced motion artifacts can be generated from the first K sub-signal u₁ associated with the first mode (e.g., mode 0). The first K sub-signal associated with the first mode (e.g., mode 0) may have minimal or reduced motion artifacts. In another example, when the iteration number is 2, the NMR echo data (e.g., NMR echo train) with reduced motion artifacts can be generated from the sum of the two corresponding first K sub-signals, e.g., such as the sum of two corresponding first sub-signals u₁ and

$${u}_{1}^{′}$$

described above. In another example, when the iteration number is 3, the NMR echo data (e.g., NMR echo train) with reduced motion artifacts can be generated from the sum of the three corresponding first K sub-signals, e.g., such as the sum of three corresponding first sub-signals u₁ and

$${u}_{1}^{′} and {u}_{1}^{″}$$

described above. The sum of the first sub-signals can be represented as

$$\sum {u}_{1} = {u}_{1} + {u}_{1}^{′} + {u}_{1}^{″} ,$$

which may have less summation terms or additional summation terms depending on the iteration number, as described above. An example of NMR echo data having reduced motion artifacts is shown in FIG. 6E.

In some implementations, the well system 100 may utilize the NMR echo data (e.g., the NMR echo train) with reduced motion artifacts for determining properties of the subsurface formation and performing well operations based on the properties. In some implementations, the well system 100 may perform an inversion operation on the NMR echo data (e.g., the NMR echo train data) with reduced motion artifacts to determine the properties of the subsurface formation, as shown in block 512 of FIG. 5. For example, a non-negative least square inversion algorithm Y=AX can be performed on the NMR echo data with reduced motion artifacts, or a multi-dimensional inversion operation (or other types of inversion operations) can be performed on the NMR echo data with reduced motion artifacts. After reducing the motion artifacts, the NMR echo data be used by various tools and products and services for NMR logging and well-related tasks, similarly as was described above in FIGS. 2 and 4.

In some implementations, the well system 100 may use a learning machine (such as a machine learning model, a machine learning neural network, or other suitable particularized machine) to receive the inputs, perform the operations, and generate the outputs described in FIGS. 2, 4 and 5. In some implementations, the operations described above in FIGS. 2, 4 and 5 that use mathematical models may instead be performed by a learning machine (or some combination of mathematical models and a learning machine) to receive the input (e.g., acquire NMR echo data having motion artifacts), perform the mode decomposition operations described in FIG. 2, 4 or 5, and generate an output (e.g., NMR echo data with reduced motion artifacts). In some implementations, the learning machine or the machine learning model may include computer code and/or a neural network and be implemented on a non-transitory computer readable medium, circuitry, and/or any other logic components configured to perform the operations described herein.

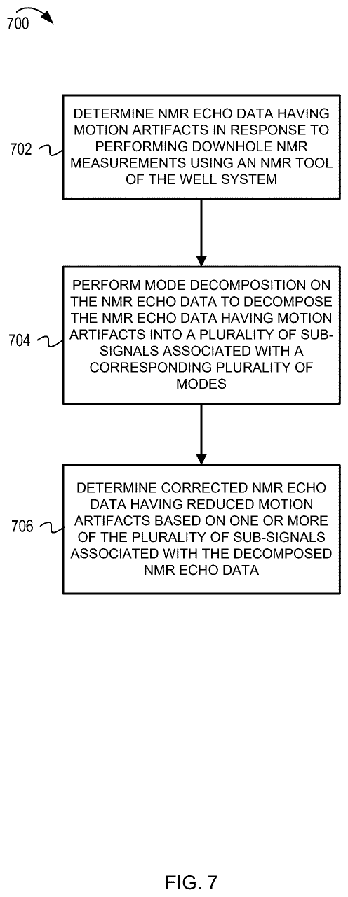

FIG. 7 is a flowchart 700 of example operations for obtaining nuclear magnetic resonance (NMR) measurements of a subsurface formation in a well system, according to some implementations. In some implementations, NMR echo data having motion artifacts is determined in response to performing downhole NMR measurements using an NMR tool of the well system (block 702). In some implementations, mode decomposition is performed on the NMR echo data to decompose the NMR echo data having motion artifacts into a plurality of sub-signals associated with a corresponding plurality of modes (block 704). In some implementations, corrected NMR echo data having reduced motion artifacts is determined based on one or more of the plurality of sub-signals associated with the decomposed NMR echo data (block 706).

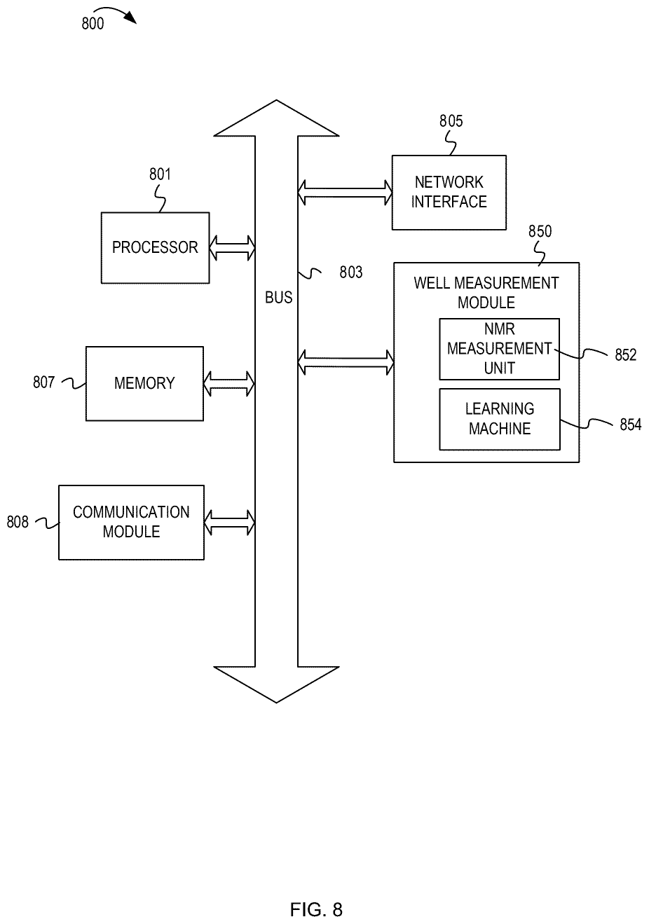

FIG. 8 depicts an example computer system of a well system for performing NMR measurements of a subsurface formation, according to some implementations. In some implementations, the computer system 800 may be an example of a computer system that may be used during the operation of the well system, such as the computer system 110 shown in FIG. 1. For example, the computer system 800 may be a standalone computer system (such as a workstation, laptop, or desktop), or may be partially or fully integrated into other surface equipment of the well system (e.g., control panel or truck). In some implementations, the computer system 800 may be implemented partially or fully in downhole components of the well system (e.g., within the NMR tool and/or work string and/or well tubing) or the computing functions of the computer system 800 may be distributed across both downhole components (e.g., NMR tool and/or work string) and surface equipment (e.g., workstation or other computer subsystem). The computer system 800 may include one or more processors 801 (possibly including multiple cores, multiple nodes, and/or implementing multi-threading, etc.). The computer system 800 may include memory 807. The memory 807 may be system memory or any type or implementation of machine or computer readable media having instructions that are executable by the one or more processors 801 to implement the operations described in FIGS. 1-7. The memory 807 may be system memory or any type or implementation of machine or computer readable and writable media having the ability to receive, process and/or store measurement data from well devices and tools (including those described in FIGS. 1-7). The computer system 800 also may include a bus 803 and a network interface 805. The computer system 800 also may include a communications module 808 that may control wired and wireless communications, such as communicating with downhole devices or tools and communicating with other surface equipment. The computer system 800 also may include at least a well measurement module 850, among other processing units or modules that are used during the operation of the well system and the well tools described herein (not shown for simplicity). The well measurement module 850 may include an NMR measurement unit 852 and a learning machine 854. In some implementations, the NMR measurement unit 852 may control above ground and downhole equipment and tools to obtain measurement data, such as controlling an NMR tool that can take NMR measurements downhole of a subsurface formation for NMR logging, as described in FIGS. 1-7. The NMR measurement unit 852 may also cause the NMR tool to generate NMR pulses and may receive, process and analyze NMR measurements, such as NMR echo data. In some implementations, the NMR measurement unit 852 may perform the operations described above in FIGS. 1-7 for obtaining NMR echo data, performing mode decomposition and related operations for reducing motion artifacts in the NMR echo data, and generating NMR echo data with reduced motion artifacts. In some implementations, the learning machine 854 (or a machine learning model) may include computer code and/or a neural network and be implemented on a non-transitory computer readable medium, circuitry, and/or any other logic components configured to perform the operations described above in FIGS. 1-7. The learning machine 854 may implement supervised machine learning and/or neural network to perform the operations described above in FIGS. 1-7, including inputting NMR echo data, performing mode decomposition and related operations for reducing motion artifacts in the NMR echo data, and outputting NMR echo data with reduced motion artifacts. In some implementations, the NMR measurement unit 852 may work in conjunction with the learning machine 854 to perform the operations described above in FIGS. 1-7. In some implementations, the NMR measurement unit 852 (in conjunction with other control and processing units of the computer system 800) may utilize the NMR measurement data (e.g., NMR echo data) for determining properties of the subsurface formation and performing and/or modifying well operations (or well parameters/attributes) based on the determined properties of the subsurface formation, as described above. The functionality described herein may be implemented with an application-specific integrated circuit, in logic implemented in the processor(s) 801, in a co-processor on a peripheral device or card, etc. Further, implementations may include fewer or additional components not illustrated in FIG. 8. The processor(s) 801 and the network interface 805 may be coupled to the bus 803. Although illustrated as being coupled to the bus 803, the memory 807 may be coupled to the processor(s) 801.

NMR logging is possible because when an assembly of magnetic moments, such as those of hydrogen nuclei, are exposed to a static magnetic field they tend to align along the direction of the magnetic field, resulting in bulk magnetization. The rate at which equilibrium is established in such bulk magnetization upon provision of a static magnetic field is characterized by the parameter T1, referred to as the spin-lattice relaxation time. Another related NMR logging parameter is T2, referred to as the spin-spin relaxation time constant (also referred to as the transverse relaxation time), which is an expression of the relaxation due to nuclear spins dephasing. NMR logging has two main experiments in oil field downhole usage. The first experiment is to assess T1 buildup of magnetization, and the second experiment is to observe the decay of magnetization once it has been excited, in which the decay has a time constant of T2.

Measurement of T1 is indirect and is done by varying the polarization times after magnetization has, through some means, been nullified or inverted. For downhole observation, an NMR measurement technique, designed by Carr, Purcell, Meiboom, and Gill and, hence, referred to as CPMG, is used. It is considered a T2 measurement. As described previously, CPMG has an excitation pulse followed by several refocusing pulses to counter the magnetic gradients in downhole NMR systems. A T1 sequence is typically performed as: Nullification Pulse—WaitTime—Excitation Pulse—Refocusing pulses. In some cases, the T1 sequence has several different wait times. The number of refocusing pulses may be as few as 3 and as many as associated electronics are configured to handle (e.g., acquire and/or process).

A portion of the hydrogen nuclei spins in the earth formation are, in the aggregate, caused to be aligned with the magnetic field induced in the earth formation by a magnet and result in a net magnetization of the formation. The NMR tool (e.g., such as the NMR tool 120 in FIG. 1) also includes at least one antenna positioned near the magnet (which could be an assembly of magnets) and shaped so that a pulse of RF power conducted through the antenna induces a magnetic field in the earth formation substantially orthogonal to the field induced by the magnet. A receiving antenna (which may be the same antenna as the one that generates the initial RF pulse) is electrically connected to a receiver, which detects, and measures voltages induced in the receiving antenna by precessional motion of nuclei spins.

An NMR measurement involves a plurality of pulses grouped into pulse sequences, most frequently of a type known as CMPG pulsed spin echo sequences. Each CPMG sequence consists of an excitation pulse, which may be a 90-degree (i.e., π/2) pulse, followed by several refocusing pulses, which may be 180-degree (i.e., π) rotation pulses. The excitation pulse rotates the proton spins into the transverse plane and the refocusing pulses generate a sequence of spin echoes by refocusing the transverse magnetization after each spin echo defocuses.

NMR well logging data are sensitive to motion of the NMR tool. In an example in which the NMR tool is used in a logging while drilling (LWD) or a measurement while drilling (MWD) context, a lateral motion (e.g., vibration) and rotational movement of drilling operations may cause distortion of the NMR well logging data and, in some cases, an inability to acquire a spin echo signal representing transversal NMR relaxation (i.e., T2 relaxation).

While rotational sensitivity may be reduced by designing the NMR tool to be essentially axially symmetrical, the longitudinal and lateral displacement due to NMR tool motion (e.g., vibration), such as while drilling, remains problematic for NMR data acquisition in a LWD or MWD context.

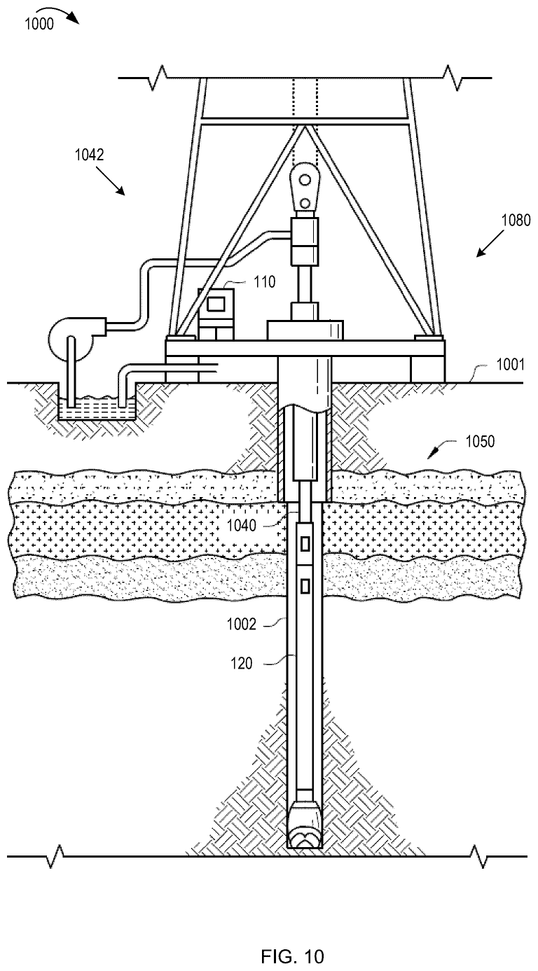

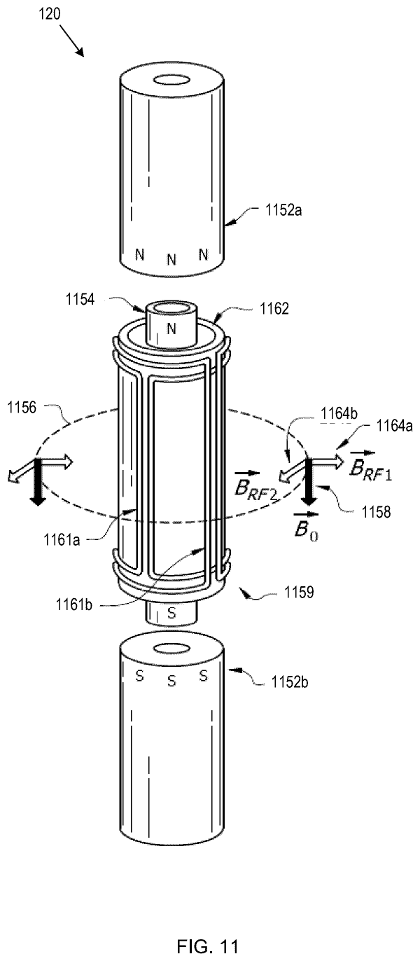

In some implementations, the NMR logging operations can be performed in connection with various types of downhole operations at various stages in the lifetime of a well system. Structural attributes and components of the surface equipment and NMR tool can be adapted for various types of NMR logging operations. For example, NMR logging may be performed during wireline logging operations (e.g., see FIG. 10), during drilling operations (e.g., see FIG. 11), or in other contexts. Accordingly, the surface equipment and the NMR tool may include, or may operate in connection with drilling equipment, wireline logging equipment, or other equipment for other types of operations. As another example, NMR logging may be performed in an offshore or subsea environment. Accordingly, the surface equipment may be arranged on a drill ship or other offshore drilling vessel, and the NMR tool operates in connection with offshore drilling equipment, offshore wireline logging equipment, or other equipment for use with offshore operations.

FIG. 9 shows an example well system 900 that includes the NMR tool 120 in a wireline logging environment, according to some implementations. The NMR tool 120 may be an example of the NMR tool 120 shown in FIG. 1. In some example wireline logging operations, the surface equipment 980 may include a platform above the surface equipped with a derrick 981 that supports a wireline cable 982 that extends into the wellbore 902 through the wellhead 905. Wireline logging operations can be performed, for example, after a drill string is removed from the wellbore 902, to allow the NMR tool 120 to be lowered by wireline or logging cable into the wellbore 902.

FIG. 10 shows an example well system 1000 that includes the NMR tool 120 in a drilling environment, according to some implementations. For example, the drilling environment may include performing logging while drilling (LWD) operations or a measurement while drilling (MWD) operations. The NMR tool 120 may be an example of the NMR tool 120 shown in FIG. 1. Drilling is commonly carried out using a string of drill pipes connected together to form a drill string 1040 that is lowered through a rotary table into the wellbore 1002. In some cases, a drilling rig 1042 at the surface 1001 supports the drill string 1040, as the drill string 1040 is operated to drill a wellbore penetrating the subsurface formation 1050. The drill string 1040 may include, for example, a kelly, drill pipe, a bottomhole assembly, and other components. The bottomhole assembly on the drill string may include drill collars, drill bits, the NMR tool 120, and other components, including additional logging tools. The additional logging tools may include MWD tools, LWD tools, and others.

In some implementations, the NMR tool 120 is configured to obtain NMR measurements from the subsurface formation 1050. As shown, for example, in FIG. 10, the NMR tool 120 can be suspended in the wellbore 1002 by a coiled tubing, wireline cable, or another structure that connects the tool to a surface control unit or other components of the surface equipment 1080. In some example implementations, the NMR tool 120 is lowered to the bottom of a region of interest and subsequently pulled upward (e.g., at a substantially constant speed) through the region of interest. As shown, for example, in FIG. 10, the NMR tool 120 can be deployed in the wellbore 1002 on jointed drill pipe, hard wired drill pipe, or other deployment hardware. In some example implementations, the NMR tool 120 collects data (e.g., measurement data) during drilling operations as it moves downward through the region of interest. In some example implementations, the NMR tool 120 collects data while the drill string 1040 is moving, for example, while it is being tripped in or tripped out of the wellbore 1002.

In some implementations, the NMR tool 120 collects data at discrete logging points in the wellbore 1002. For example, the NMR tool 120 can move upward or downward incrementally to each logging point at a series of depths in the wellbore 1002. At each logging point, instruments in the NMR tool 120 perform measurements on the subsurface formations 1050. The measurement data can be communicated to the computer system 110 for storage, processing, and analysis. Such data may be gathered and analyzed during drilling operations (e.g., during LWD/MWD operations), during wireline logging operations, or during other types of activities. The computer system 110 shown in FIGS. 9 and 10 may be configured to receive and analyze the measurement data from the NMR tool 120 to detect properties of the subsurface formation 1050, as previously described above in FIG. 1.

In some implementations, the NMR tool 120 obtains NMR signals by polarizing nuclear spins in the subsurface formation 1050 and pulsing the nuclei with a radio frequency (RF) magnetic field. Various pulse sequences (i.e., series of radio frequency pulses, delays, and other operations) can be used to obtain NMR signals, including the CPMG sequence (in which the spins are first tipped using an excitation (or tipping) pulse followed by a series of refocusing pulses), the Optimized Refocusing Pulse Sequence (ORPS) (in which the refocusing pulses are less than 180°), a saturation recovery pulse sequence, and other pulse sequences. The NMR tool 120 collects measurements relating to spin relaxation time (e.g., T1, T2) distributions as a function of depth or position in the borehole. The NMR tool 120 has a magnet, magnetically permeable material, antenna, and supporting electronics. The permanent magnet in the tool causes the nuclear spins to build up into a cohesive magnetization. The T2 is measured through the decay of excited magnetization while T1 is measured by the buildup of magnetization.

The computer system 110 is configured to process (e.g., invert, transform, etc.) the acquired spin echo signals (or other NMR data) to obtain an NMR signal, such as a relaxation-time distribution (e.g., a distribution of transverse relaxation times T2, or a distribution of longitudinal relaxation times T1, or both). For example, the acquired spin echo signals are integrated using acquisition windows having different durations to generate the different NMR echo train signals. The relaxation-time distribution can be used to determine various physical properties of the formation by solving one or more inverse problems. In some cases, relaxation-time distributions are acquired for multiple logging points and used by the computer system 110 to train a model of the subsurface formation 1050. In some cases, relaxation-time distributions are acquired for multiple logging points and used by the computer system 110 to predict properties of the subsurface formation 1050. The relaxation data may also be referred to as NMR echo train data.

FIG. 11 is a diagram of an example NMR magnet and antenna(s) configuration of an NMR tool 120, according to some implementations. The example NMR tool 120 includes a magnet assembly that generates a static magnetic field to produce polarization, and an antenna assembly that generates a radio frequency (RF) magnetic field to excite nuclei and acquires NMR signals from the surrounding formation. In the non-limiting example shown in FIG. 11, the magnet assembly that includes the end piece magnets 1152a, 1152b and a central magnet 1154 generates the static magnetic field in the volume of investigation 1156. The poles of the central magnet 1154 (e.g., north (N) and south(S)) face the like poles of the proximal end piece magnets 1152a, 1152b. The central magnet 1154 is useful to shape and strengthen the static magnetic field in the volume of investigation 1156. In this example, the volume of investigation 1156 is approximately a cylindrical shell. In the volume of investigation 1156, the direction of the static magnetic field (shown as the solid black arrow 1158) is parallel to the longitudinal axis of the wellbore. In some examples, a magnet configuration with a bigger central magnet can be used to create a double pole strength and therefore increase the strength of the magnetic field (e.g., up to 50-150 Gauss or higher in some instances).

In the non-limiting example shown in FIG. 11, the antenna assembly 1159 includes two mutually orthogonal transversal dipole antennas 1161a, 1161b. In some instances, the NMR tool 120 can be implemented with a single transversal-dipole antenna. For example, one of the orthogonal transversal-dipole antennas 1161a, 1161b may be omitted from the antenna assembly 1159. The example orthogonal transversal-dipole antenna 1161a, 1161b shown in FIG. 11 are placed on an outer surface of a soft magnetic core 1162, which is useful for RF magnetic flux concentration. The antenna assembly 1159 generates two orthogonal RF magnetic fields 1164a (e.g., produced by the antenna 1161a) and 1164b (e.g., produced by the antenna 1161b). The two RF magnetic fields 1164a, 1164b have a phase shift of 90°. Accordingly, the RF magnetic fields 1164a, 1164b generate a circular polarized RF magnetic field to excite NMR in the surrounding formation more efficiently. It is also possible to only transmit with one antenna, even if a second antenna is included in the assembly. For example, the second antenna could be used only to receive NMR signals in this configuration. The same two orthogonal transversal-dipole antennas 1161a, 1161b are used to receive NMR signals from the surrounding formation. The received NMR signals are from induced currents from the NMR magnetization. The signals in the orthogonal transversal-dipole antennas 1161a, 1161b, may then be processed (e.g., by the computer system 110 of FIGS. 1 and 9-10) together in order to increase a signal-to-noise ratio (SNR) of the acquired NMR data.

In some implementations, the antenna assembly 1159 additionally or alternatively includes an integrated coil set that performs the operations of the two orthogonal transversal-dipole antennas 1161a, 1161b. For example, the integrated coil may be useful (e.g., instead of the two orthogonal transversal-dipole antennas 1161a, 1161b) to produce circular polarization and perform quadrature coil detection. Examples of integrated coil sets that can be adapted to perform such operations include multi-coil or complex single-coil arrangements, such as, for example, birdcage coils used for high-field magnetic resonance imaging (MRI). It is noted that the specific geometry and/or configuration of the NMR tool 120 is not necessarily limited to that shown in FIG. 11, and in other implementations, the NMR tool 120 may have different geometry and/or configurations.

Although some example well systems are described in FIGS. 1-11, it is noted, however, that the techniques and operations for performing NMR measurements and reducing motion artifacts from the NMR measurements described in FIGS. 1-11 can be used in any type of well system in the oil and gas industry.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain, or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

None of the implementations described herein may be performed exclusively in the human mind nor exclusively using pencil and paper. None of the implementations described herein may be performed without computerized components such as those described herein. Some implementations may perform additional operations, fewer operations, operations in parallel or in a different order, and some operations differently.

While the aspects of the disclosure are described with reference to various implementations and exploitations, it will be understood that these aspects are illustrative and that the scope of the claims is not limited to them. In general, techniques for performing NMR measurements and reducing motion artifacts from the NMR measurements as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

As used herein, the term “or” is inclusive unless otherwise explicitly noted. Thus, the phrase “at least one of A, B, or C” is satisfied by any element from the set {A, B, C} or any combination thereof, including multiples of any element.

Furthermore, unless otherwise specified, use of the terms “up,” “upper,” “upward,” “uphole,” “upstream,” or other like terms shall be construed as generally away from the bottom, terminal end of a well; likewise, use of the terms “down,” “lower,” “downward,” “downhole,” or other like terms shall be construed as generally toward the bottom, terminal end of the well, regardless of the wellbore orientation. Use of any one or more of the foregoing terms shall not be construed as denoting positions along a perfectly vertical axis. In some instances, a part near the end of the well can be horizontal or even slightly directed upwards. Unless otherwise specified, use of the term “subterranean formation” shall be construed as encompassing both areas below exposed earth and areas below earth covered by water such as ocean or fresh water.

### EXAMPLE EMBODIMENTS

Example Embodiments can include the following:

Embodiment #1: A method for obtaining nuclear magnetic resonance (NMR) measurements of a subsurface formation in a well system, comprising: determining NMR echo data having motion artifacts in response to performing downhole NMR measurements using an NMR tool of the well system; performing mode decomposition on the NMR echo data to decompose the NMR echo data having the motion artifacts into a plurality of sub-signals associated with a corresponding plurality of modes; and determining corrected NMR echo data having reduced motion artifacts based on one or more of the plurality of sub-signals associated with the decomposed NMR echo data.

Embodiment #2: The method of Embodiment #1, further comprising: determining a total porosity associated with the subsurface formation; determining a ground truth based, at least in part, on the total porosity; selecting a subset of the plurality of sub-signals that minimize a difference error between a combination of the selected subset of the plurality of sub-signals and the ground truth, wherein the selected subset of the plurality of sub-signals are associated with a subset of the corresponding plurality of modes; and determining the corrected NMR echo data having the reduced motion artifacts based on the selected subset of the plurality of sub-signals associated with the decomposed NMR echo data.

Embodiment #3: The method of Embodiment #2, wherein selecting the subset of the plurality of sub-signals that minimize the difference error between the combination of the selected subset of the plurality of sub-signals and the ground truth includes: selecting the subset of the plurality of sub-signals that minimize a root mean squared error (RMSE) between the combination of the selected subset of the plurality of sub-signals and the ground truth, wherein the selected subset of the plurality of sub-signals includes a first sub-signal associated with a corresponding first mode and one or more additional sub-signals associated with one or more corresponding additional modes.

Embodiment #4: The method of Embodiment #3, wherein selecting the subset of the plurality of sub-signals that minimize the RMSE between the combination of the selected subset of the plurality of sub-signals and the ground truth includes selecting the subset of the plurality of sub-signals and hyperparameters that minimize the RMSE between the combination of the selected subset of the plurality of sub-signals and the ground truth.

Embodiment #5: The method of Embodiment #1, further comprising: determining motion data associated with the NMR tool; performing the mode decomposition with a modification using the determined motion data to decompose the NMR echo data having the motion artifacts into a plurality of modified sub-signals associated with the corresponding plurality of modes; selecting a subset of the plurality of modified sub-signals that minimize a difference error between a combination of the selected subset of the plurality of modified sub-signals and a ground truth, wherein the selected subset of the plurality of modified sub-signals are associated with a subset of the corresponding plurality of modes; and determining the corrected NMR echo data having the reduced motion artifacts based on the selected subset of the plurality of modified sub-signals associated with the decomposed NMR echo data.

Embodiment #6: The method of Embodiment #5, wherein selecting the subset of the plurality of modified sub-signals that minimize the difference error between the combination of the selected subset of the plurality of modified sub-signals and the ground truth includes: selecting the subset of the plurality of modified sub-signals that minimize a root mean squared error (RMSE) between the combination of the selected subset of the plurality of modified sub-signals and the ground truth, wherein the selected subset of the plurality of modified sub-signals includes a first modified sub-signal associated with a corresponding first mode and one or more additional modified sub-signals associated with one or more corresponding additional modes.

Embodiment #7: The method of Embodiment #6, wherein selecting the subset of the plurality of modified sub-signals that minimize the RMSE between the combination of the selected subset of the plurality of modified sub-signals and the ground truth includes selecting the subset of the plurality of modified sub-signals and hyperparameters that minimize the RMSE between the combination of the selected subset of the plurality of modified sub-signals and the ground truth.

Embodiment #8: The method of Embodiment #6, wherein the determined motion data includes frequence data obtained from an accelerometer.

Embodiment #9: The method of Embodiment #1, wherein determining the corrected NMR echo data having the reduced motion artifacts based on the one or more of the plurality of sub-signals associated with the decomposed NMR echo data includes: selecting a first sub-signal of the plurality of sub-signals as the corrected NMR echo data having the reduced motion artifacts, wherein the first sub-signal is associated with a first mode of the corresponding plurality of modes.

Embodiment #10: The method of Embodiment #1, wherein determining the corrected NMR echo data having the reduced motion artifacts based on the one or more of the plurality of sub-signals associated with the decomposed NMR echo data includes: selecting one or more first sub-signals associated with one or more mode decompositions, wherein each first sub-signal is associated with a first mode of the corresponding plurality of modes; and determining the corrected NMR echo data having the reduced motion artifacts based on the one or more first sub-signals associated with one or more mode decompositions.

Embodiment #11: The method of Embodiment #1, further comprising: determining properties of the subsurface formation from the NMR echo data having the reduced motion artifacts.

Embodiment #12: The method of Embodiment #11, further comprising: modifying at least one of a well operation or a well operation attribute based on the determined properties of the subsurface formation.

Embodiment #13: The method of Embodiment #1, wherein performing the mode decomposition on the NMR echo data to decompose the NMR echo data having the motion artifacts into the plurality of sub-signals associated with the corresponding plurality of modes and determining the corrected NMR echo data having the reduced motion artifacts based on the one or more of the plurality of sub-signals associated with the decomposed NMR echo data are performed using a trained learning machine of the well system that implements machine learning.

Embodiment #14: A well system for obtaining nuclear magnetic resonance (NMR) measurements of a subsurface formation, the well system comprising: one or more processors; and a computer-readable storage medium having instructions stored thereon that are executable by the one or more processors to cause the well system to: determining NMR echo data having motion artifacts in response to performing downhole NMR measurements using an NMR tool of the well system; performing mode decomposition on the NMR echo data to decompose the NMR echo data having the motion artifacts into a plurality of sub-signals associated with a corresponding plurality of modes; and determining corrected NMR echo data having reduced motion artifacts based on one or more of the plurality of sub-signals associated with the decomposed NMR echo data.

Embodiment #15: The well system of Embodiment #14, further comprising instructions that cause the well system to: determine a total porosity associated with the subsurface formation; determine a ground truth based, at least in part, on the total porosity; select a subset of the plurality of sub-signals that minimize a difference error between a combination of the selected subset of the plurality of sub-signals and the ground truth, wherein the selected subset of the plurality of sub-signals are associated with a subset of the corresponding plurality of modes; and determine the corrected NMR echo data having the reduced motion artifacts based on the selected subset of the plurality of sub-signals associated with the decomposed NMR echo data.

Embodiment #16: The well system of Embodiment #15, wherein the instructions that cause the well system to select the subset of the plurality of sub-signals that minimize the difference error between the combination of the selected subset of the plurality of sub-signals and the ground truth include instructions that cause the well system to: select the subset of the plurality of sub-signals that minimize a root mean squared error (RMSE) between the combination of the selected subset of the plurality of sub-signals and the ground truth, wherein the selected subset of the plurality of sub-signals includes a first sub-signal associated with a corresponding first mode and one or more additional sub-signals associated with one or more corresponding additional modes.

Embodiment #17: The well system of Embodiment #14, further comprising instructions that cause the well system to: determine motion data associated with the NMR tool; perform the mode decomposition with a modification using the determined motion data to decompose the NMR echo data having the motion artifacts into a plurality of modified sub-signals associated with the corresponding plurality of modes; select a subset of the plurality of modified sub-signals that minimize a difference error between a combination of the selected subset of the plurality of modified sub-signals and a ground truth, wherein the selected subset of the plurality of modified sub-signals are associated with a subset of the corresponding plurality of modes; and determine the corrected NMR echo data having the reduced motion artifacts based on the selected subset of the plurality of modified sub-signals associated with the decomposed NMR echo data.

Embodiment #18: The well system of Embodiment #17, wherein the instructions that cause the well system to select the subset of the plurality of modified sub-signals that minimize the difference error between the combination of the selected subset of the plurality of modified sub-signals and the ground truth include instructions that cause the well system to: select the subset of the plurality of modified sub-signals at minimize a root mean squared error (RMSE) between the combination of the selected subset of the plurality of modified sub-signals and the ground truth, wherein the selected subset of the plurality of modified sub-signals includes a first modified sub-signal associated with a corresponding first mode and one or more additional modified sub-signals associated with one or more corresponding additional modes.

Embodiment #19: The well system of Embodiment #14, wherein the instructions that cause the well system to determine the corrected NMR echo data having the reduced motion artifacts based on the one or more of the plurality of sub-signals associated with the decomposed NMR echo data include instructions that cause the well system to: select a first sub-signal of the plurality of sub-signals as the corrected NMR echo data having the reduced motion artifacts, wherein the first sub-signal is associated with a first mode of the corresponding plurality of modes.

Embodiment #20: A non-transitory computer-readable storage medium having instructions stored thereon that are executable by one or more processors of a well system, the well system for obtaining nuclear magnetic resonance (NMR) measurements of a subsurface formation, the instructions comprising: instructions for determining NMR echo data having motion artifacts in response to performing downhole NMR measurements using an NMR tool of the well system; instructions for performing mode decomposition on the NMR echo data to decompose the NMR echo data having the motion artifacts into a plurality of sub-signals associated with a corresponding plurality of modes; and instructions for determining corrected NMR echo data having reduced motion artifacts based on one or more of the plurality of sub-signals associated with the decomposed NMR echo data.

Embodiment #21: The non-transitory computer-readable storage medium of Embodiment #20, further comprising: instructions for determining a total porosity associated with the subsurface formation; instructions for determining a ground truth based, at least in part, on the total porosity; instructions for selecting a subset of the plurality of sub-signals that minimize a difference error between a combination of the selected subset of the plurality of sub-signals and the ground truth, wherein the selected subset of the plurality of sub-signals are associated with a subset of the corresponding plurality of modes; and instructions for determining the corrected NMR echo data having the reduced motion artifacts based on the selected subset of the plurality of sub-signals associated with the decomposed NMR echo data.

Embodiment #22: The non-transitory computer-readable storage medium of Embodiment #20, further comprising: instructions for determining motion data associated with the NMR tool; instructions for performing the mode decomposition with a modification using the determined motion data to decompose the NMR echo data having the motion artifacts into a plurality of modified sub-signals associated with the corresponding plurality of modes; instructions for selecting a subset of the plurality of modified sub-signals that minimize a difference error between a combination of the selected subset of the plurality of modified sub-signals and a ground truth, wherein the selected subset of the plurality of modified sub-signals are associated with a subset of the corresponding plurality of modes; and instructions for determining the corrected NMR echo data having the reduced motion artifacts based on the selected subset of the plurality of modified sub-signals associated with the decomposed NMR echo data.

Embodiment #23: The non-transitory computer-readable storage medium of Embodiment #20, wherein the instructions for determining the corrected NMR echo data having the reduced motion artifacts based on the one or more of the plurality of sub-signals associated with the decomposed NMR echo data include: instructions for selecting a first sub-signal of the plurality of sub-signals as the corrected NMR echo data having the reduced motion artifacts, wherein the first sub-signal is associated with a first mode of the corresponding plurality of modes.

What is claimed is:

1. A method for obtaining nuclear magnetic resonance (NMR) measurements of a subsurface formation in a well system, comprising:
determining NMR echo data having motion artifacts in response to performing downhole NMR measurements using an NMR tool of the well system;
performing mode decomposition on the NMR echo data to decompose the NMR echo data having the motion artifacts into a plurality of sub-signals associated with a corresponding plurality of modes; and
determining corrected NMR echo data having reduced motion artifacts based on one or more of the plurality of sub-signals associated with the decomposed NMR echo data.

2. The method of claim 1, further comprising:
determining a total porosity associated with the subsurface formation;
determining a ground truth based, at least in part, on the total porosity;
selecting a subset of the plurality of sub-signals that minimize a difference error between a combination of the selected subset of the plurality of sub-signals and the ground truth, wherein the selected subset of the plurality of sub-signals are associated with a subset of the corresponding plurality of modes; and
determining the corrected NMR echo data having the reduced motion artifacts based on the selected subset of the plurality of sub-signals associated with the decomposed NMR echo data.

3. The method of claim 2, wherein selecting the subset of the plurality of sub-signals that minimize the difference error between the combination of the selected subset of the plurality of sub-signals and the ground truth includes:
selecting the subset of the plurality of sub-signals that minimize a root mean squared error (RMSE) between the combination of the selected subset of the plurality of sub-signals and the ground truth, wherein the selected subset of the plurality of sub-signals includes a first sub-signal associated with a corresponding first mode and one or more additional sub-signals associated with one or more corresponding additional modes.

4. The method of claim 3, wherein selecting the subset of the plurality of sub-signals that minimize the RMSE between the combination of the selected subset of the plurality of sub-signals and the ground truth includes selecting the subset of the plurality of sub-signals and hyperparameters that minimize the RMSE between the combination of the selected subset of the plurality of sub-signals and the ground truth.

5. The method of claim 1, further comprising:
determining motion data associated with the NMR tool;
performing the mode decomposition with a modification using the determined motion data to decompose the NMR echo data having the motion artifacts into a plurality of modified sub-signals associated with the corresponding plurality of modes;
selecting a subset of the plurality of modified sub-signals that minimize a difference error between a combination of the selected subset of the plurality of modified sub-signals and a ground truth, wherein the selected subset of the plurality of modified sub-signals are associated with a subset of the corresponding plurality of modes; and
determining the corrected NMR echo data having the reduced motion artifacts based on the selected subset of the plurality of modified sub-signals associated with the decomposed NMR echo data.

6. The method of claim 5, wherein selecting the subset of the plurality of modified sub-signals that minimize the difference error between the combination of the selected subset of the plurality of modified sub-signals and the ground truth includes:
selecting the subset of the plurality of modified sub-signals that minimize a root mean squared error (RMSE) between the combination of the selected subset of the plurality of modified sub-signals and the ground truth, wherein the selected subset of the plurality of modified sub-signals includes a first modified sub-signal associated with a corresponding first mode and one or more additional modified sub-signals associated with one or more corresponding additional modes.

7. The method of claim 6, wherein selecting the subset of the plurality of modified sub-signals that minimize the RMSE between the combination of the selected subset of the plurality of modified sub-signals and the ground truth includes selecting the subset of the plurality of modified sub-signals and hyperparameters that minimize the RMSE between the combination of the selected subset of the plurality of modified sub-signals and the ground truth.

8. The method of claim 6, wherein the determined motion data includes frequence data obtained from an accelerometer.

9. The method of claim 1, wherein determining the corrected NMR echo data having the reduced motion artifacts based on the one or more of the plurality of sub-signals associated with the decomposed NMR echo data includes:
selecting a first sub-signal of the plurality of sub-signals as the corrected NMR echo data having the reduced motion artifacts, wherein the first sub-signal is associated with a first mode of the corresponding plurality of modes.

10. The method of claim 1, wherein determining the corrected NMR echo data having the reduced motion artifacts based on the one or more of the plurality of sub-signals associated with the decomposed NMR echo data includes:
selecting one or more first sub-signals associated with one or more mode decompositions, wherein each first sub-signal is associated with a first mode of the corresponding plurality of modes; and
determining the corrected NMR echo data having the reduced motion artifacts based on the one or more first sub-signals associated with one or more mode decompositions.

11. The method of claim 1, further comprising:
determining properties of the subsurface formation from the NMR echo data having the reduced motion artifacts.

12. The method of claim 11, further comprising:
modifying at least one of a well operation or a well operation attribute based on the determined properties of the subsurface formation.

13. The method of claim 1, wherein performing the mode decomposition on the NMR echo data to decompose the NMR echo data having the motion artifacts into the plurality of sub-signals associated with the corresponding plurality of modes and determining the corrected NMR echo data having the reduced motion artifacts based on the one or more of the plurality of sub-signals associated with the decomposed NMR echo data are performed using a trained learning machine of the well system that implements machine learning.

14. A well system for obtaining nuclear magnetic resonance (NMR) measurements of a subsurface formation, the well system comprising:
one or more processors; and
a computer-readable storage medium having instructions stored thereon that are executable by the one or more processors to cause the well system to:
determining NMR echo data having motion artifacts in response to performing downhole NMR measurements using an NMR tool of the well system;
performing mode decomposition on the NMR echo data to decompose the NMR echo data having the motion artifacts into a plurality of sub-signals associated with a corresponding plurality of modes; and
determining corrected NMR echo data having reduced motion artifacts based on one or more of the plurality of sub-signals associated with the decomposed NMR echo data.

15. The well system of claim 14, further comprising instructions that cause the well system to:
determine a total porosity associated with the subsurface formation;
determine a ground truth based, at least in part, on the total porosity;
select a subset of the plurality of sub-signals that minimize a difference error between a combination of the selected subset of the plurality of sub-signals and the ground truth, wherein the selected subset of the plurality of sub-signals are associated with a subset of the corresponding plurality of modes; and
determine the corrected NMR echo data having the reduced motion artifacts based on the selected subset of the plurality of sub-signals associated with the decomposed NMR echo data.

16. The well system of claim 15, wherein the instructions that cause the well system to select the subset of the plurality of sub-signals that minimize the difference error between the combination of the selected subset of the plurality of sub-signals and the ground truth include instructions that cause the well system to:
select the subset of the plurality of sub-signals that minimize a root mean squared error (RMSE) between the combination of the selected subset of the plurality of sub-signals and the ground truth, wherein the selected subset of the plurality of sub-signals includes a first sub-signal associated with a corresponding first mode and one or more additional sub-signals associated with one or more corresponding additional modes.

17. The well system of claim 14, further comprising instructions that cause the well system to:
determine motion data associated with the NMR tool;
perform the mode decomposition with a modification using the determined motion data to decompose the NMR echo data having the motion artifacts into a plurality of modified sub-signals associated with the corresponding plurality of modes;
select a subset of the plurality of modified sub-signals that minimize a difference error between a combination of the selected subset of the plurality of modified sub-signals and a ground truth, wherein the selected subset of the plurality of modified sub-signals are associated with a subset of the corresponding plurality of modes; and
determine the corrected NMR echo data having the reduced motion artifacts based on the selected subset of the plurality of modified sub-signals associated with the decomposed NMR echo data.

18. The well system of claim 17, wherein the instructions that cause the well system to select the subset of the plurality of modified sub-signals that minimize the difference error between the combination of the selected subset of the plurality of modified sub-signals and the ground truth include instructions that cause the well system to:
select the subset of the plurality of modified sub-signals at minimize a root mean squared error (RMSE) between the combination of the selected subset of the plurality of modified sub-signals and the ground truth, wherein the selected subset of the plurality of modified sub-signals includes a first modified sub-signal associated with a corresponding first mode and one or more additional modified sub-signals associated with one or more corresponding additional modes.

19. The well system of claim 14, wherein the instructions that cause the well system to determine the corrected NMR echo data having the reduced motion artifacts based on the one or more of the plurality of sub-signals associated with the decomposed NMR echo data include instructions that cause the well system to:
select a first sub-signal of the plurality of sub-signals as the corrected NMR echo data having the reduced motion artifacts, wherein the first sub-signal is associated with a first mode of the corresponding plurality of modes.

20. A non-transitory computer-readable storage medium having instructions stored thereon that are executable by one or more processors of a well system, the well system for obtaining nuclear magnetic resonance (NMR) measurements of a subsurface formation, the instructions comprising:
instructions for determining NMR echo data having motion artifacts in response to performing downhole NMR measurements using an NMR tool of the well system;
instructions for performing mode decomposition on the NMR echo data to decompose the NMR echo data having the motion artifacts into a plurality of sub-signals associated with a corresponding plurality of modes; and
instructions for determining corrected NMR echo data having reduced motion artifacts based on one or more of the plurality of sub-signals associated with the decomposed NMR echo data.

21. The non-transitory computer-readable storage medium of claim 20, further comprising:
instructions for determining a total porosity associated with the subsurface formation;
instructions for determining a ground truth based, at least in part, on the total porosity;
instructions for selecting a subset of the plurality of sub-signals that minimize a difference error between a combination of the selected subset of the plurality of sub-signals and the ground truth, wherein the selected subset of the plurality of sub-signals are associated with a subset of the corresponding plurality of modes; and
instructions for determining the corrected NMR echo data having the reduced motion artifacts based on the selected subset of the plurality of sub-signals associated with the decomposed NMR echo data.

22. The non-transitory computer-readable storage medium of claim 20, further comprising:
instructions for determining motion data associated with the NMR tool;
instructions for performing the mode decomposition with a modification using the determined motion data to decompose the NMR echo data having the motion artifacts into a plurality of modified sub-signals associated with the corresponding plurality of modes;
instructions for selecting a subset of the plurality of modified sub-signals that minimize a difference error between a combination of the selected subset of the plurality of modified sub-signals and a ground truth, wherein the selected subset of the plurality of modified sub-signals are associated with a subset of the corresponding plurality of modes; and
instructions for determining the corrected NMR echo data having the reduced motion artifacts based on the selected subset of the plurality of modified sub-signals associated with the decomposed NMR echo data.

23. The non-transitory computer-readable storage medium of claim 20, wherein the instructions for determining the corrected NMR echo data having the reduced motion artifacts based on the one or more of the plurality of sub-signals associated with the decomposed NMR echo data include:
instructions for selecting a first sub-signal of the plurality of sub-signals as the corrected NMR echo data having the reduced motion artifacts, wherein the first sub-signal is associated with a first mode of the corresponding plurality of modes.
